(19) United States
(12) Patent Application Publication
(10) Pub. No.: US 2010/0217448 A1
(43) Pub. Date: Aug. 26, 2010

(54) Method for Configuring an Arrangement for Protecting, Controlling or Monitoring an Electrical Switch or Power Supply Gear

(75) Inventor: Thierry Dufaurre, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/682,651

(22) PCT Filed: Oct. 12, 2007
(86) PCT No.: PCT/EP07/09160

§ 371 Date: Apr. 12, 2010

(51) Int. Cl. G06F 1/26

(52) U.S. Cl. 700/286

(57) ABSTRACT

A method for configuring an arrangement having a command level device and at least one arrangement having a field device connected to the command level device, for protecting controlling or monitoring an electrical switch or power supply gear. A command level configuration file describing the configuration of the arrangement is generated. After replacement of the field device by a new field device, a new command level configuration file is generated to replace the old command level configuration file, taking account of the properties of the new field device and a new field device parameter data set is generated with the new command level configuration file, by means of which the new field device is parameterized, telegram configuration files being extracted from the old command level configuration file, describing the data telegram generation of the old field device and the new command level configuration file and the new field device parameter data set are generated with said telegram configuration data such that the new field device generates data telegrams with a data telegram addressing matching that of the old field device.

The invention relates to a method for configuring an arrangement which has a command level device and at least one field device connected to the command level device and is suitable for protecting, controlling or monitoring an electrical switchgear or power supply system, a command level configuration file which describes the configuration of the arrangement being generated.

Station automation systems are known to be used to protect, control and monitor electrical switchgear or power supply systems. Such a station automation system has devices, such as field devices, in particular protective devices, as well as at least one superordinate command level device, the devices interchanging information with one another in order to perform their tasks. A predefined communication technology with a transmission medium and a communication protocol is used to interchange information objects. For example, the communication protocol according to the IEC 61850 standard can be used in station automation systems.

Communication according to the IEC 61850 standard is based on the interchange of information objects which are implemented in the data models of the devices used. The data models of the devices reflect the functions from the point of view of the devices used from the respective manufacturers. Since the structuring and the scope of the device functions are determined by the respective manufacturer-specific function implementation, the individual data models and the resulting addressing scheme of the information objects to be transmitted differ. Therefore, in the case of devices from different manufacturers, the addressing schemes generally differ even though the devices provide comparable protective and control functions. With currently known devices for protecting, controlling and monitoring electrical switchgear or power supply systems, it is occasionally very complicated, on account of the different addressing schemes of devices from different manufacturers, to replace a(n) (old) field device in the system with a new field device since the parameterization of not only the field device affected by the change but also all other devices which interchange data with this field device generally must be adapted because the data model of the new field device will generally differ from that of the old field device.

For this reason, replacement of a field device in an electrical switchgear or power supply system generally requires a multiplicity of steps, for example the following:
the system configuration is updated in a system configurator in order to take into account an amended data model,
all of those areas of the electrical switchgear or power supply system whose devices are affected by the reparameterization are electrically isolated,
communication between all devices which are affected by reparameterization is deactivated,
the device parameterization of all affected devices is updated,
all reparameterized devices are restarted,
the correct function of the reparameterized devices is tested (protective test, bit test, function test), and
the isolated areas of the switchgear or power supply system are connected.

The replacement procedure described gives rise to a considerable amount of parameterization and testing. Since system operation is restricted for the duration of the device replacement procedure, additional organizational measures are required, for example the request for isolating dates for isolating the switchgear or power supply system. The described practice of isolating areas is therefore carried out only very reluctantly in electrical transmission networks, with the result that isolating operations generally have to be registered with the relevant load management unit for the affected areas at least one year in advance. Isolating operations also give rise to changes in the load management schedule which generally result in significant outage costs since the transport capacity of the transmission network is generally reduced in the case of an isolating operation.

The invention is therefore based on the object of specifying a method for configuring an arrangement having a command level device and at least one field device connected to the command level device, which method necessitates the smallest possible amount of effort when a device is changed.

On the basis of a method of the type described at the outset, this object is achieved, according to the invention, by the characterizing features of claim 1. Advantageous refinements of the method according to the invention are specified in subclaims.

The invention accordingly provides, after the field device has been replaced with a new field device, for a new command level configuration file which replaces the old command level configuration file and takes into account the properties of the new field device to be generated and for this new command level configuration file to be used to generate a new field device parameterization data record which can be used to automatically parameterize the new field device, message configuration data which describe the data message generation by the old field device being extracted from the old command level configuration file, and these message configuration data being used to form the new command level configuration file and the new field device parameterization data record in such a manner that the new field device generates data messages with data message addressing which corresponds to the data message addressing of the old field device.

An important advantage of the method according to the invention can be seen in the fact that, in this method, the data message addressing also remains unchanged when a device is changed, with the result that a change of field device is not very important for the remaining devices because the new field device behaves in exactly the same manner as the old field device, which has been replaced, when generating data messages.

One advantageous refinement of the method provides for the new command level configuration file to be formed using the old command level configuration file and a property description file for the new field device, which property description file describes the properties of the new field device. In this refinement of the method, the new command level configuration file is thus formed by joining two input files.

It is also considered to be advantageous if the old command level configuration file is an SCD file according to the IEC 61850 standard and the message configuration data are extracted from this file, and if an SCD file according to the IEC 61850 standard is likewise formed as the new command level configuration file. For example, an ICD file for the new field device according to the IEC 61850 standard is used as the property description file for the new field device.

One particularly preferred refinement of the method provides for at least one “General Object Oriented System Environment” control block, that is to say a “GOOSE” control block according to the IEC 61850 standard, to be identified in the old command level configuration file. In this case, a check can be carried out, for example, in order to determine which “Logical Device” name according to the IEC 61850 standard the GOOSE control block in the old command level configuration file is assigned to. The corresponding “Logical Device” name is preferably added to the new command level configuration file if it is not yet present in the latter.

The GOOSE control block of the old command level configuration file is preferably also set up in the new command level configuration file, to be precise with assignment to the same “Logical Device” name to which the GOOSE control block in the old command level configuration file is assigned. For example, the GOOSE control block is set up in the new command level configuration file by copying the GOOSE control block from the old command level configuration file to the new command level configuration file.

The data set entry according to the 61850 standard is preferably adapted to the device function names of the new field device inside the GOOSE control block of the new command level configuration file if the device function names of the new field device differ from those of the old field device.

The device function names of the old field device may be read from the command level configuration file, for example. The device function names of the new field device are taken from a database, for example, or are requested from an operator, preferably via a data processing system such as a PC or the like.

The assignment of the device function names of the old field device to the device function names of the new field device can likewise be taken from said database, for example, or can be requested from said operator.

The invention also relates to a configuration device for configuring an arrangement which has a command level device and at least one field device connected to the command level device and is intended to protect, control or monitor an electrical switchgear or power supply system.

In this respect, the invention provides for the configuration device to be suitable for forming a new command level configuration file using an old command level configuration file and a property description file for the new field device, which property description file describes the properties of the new field device.

With regard to the advantages of the configuration device according to the invention, reference is made to the above statements made in connection with the method according to the invention since the advantages of the method according to the invention essentially correspond to those of the configuration device according to the invention.

The configuration device preferably has a data processing system in which a program which is suitable for configuring an arrangement which has a command level device and at least one field device connected to the command level device is installed.

The invention also relates to a computer program product for installation in a configuration device as described above.

According to the invention, the computer program product can be used to program a data processing system in such a manner that the latter is suitable for configuring an arrangement which has a command level device and at least one field device connected to the command level device.

The invention is explained in more detail below using exemplary embodiments. In the drawing, by way of example:

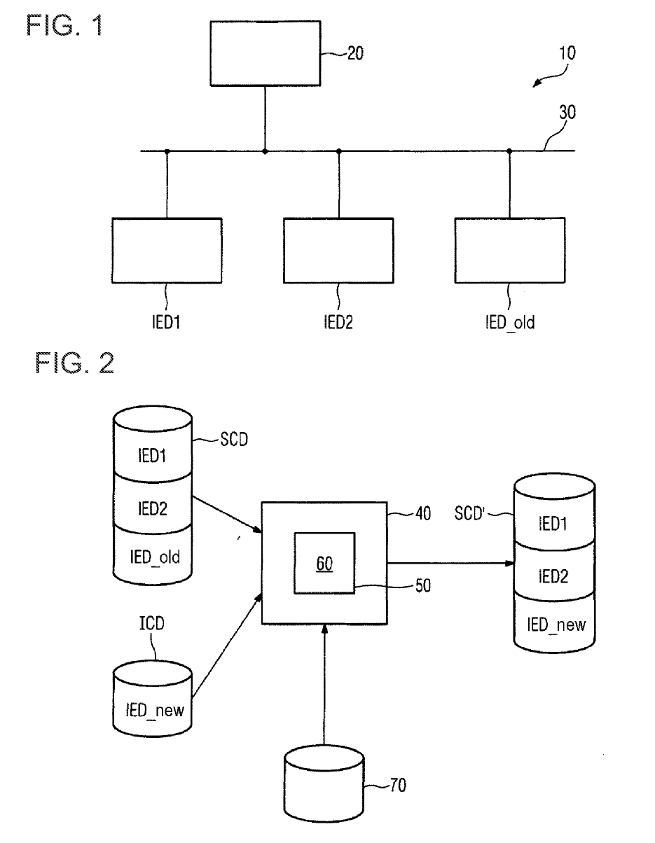

FIG. 1 shows an exemplary embodiment of an arrangement having field devices and a command level device,

FIG. 2 shows an exemplary embodiment of a configuration device for configuring the arrangement according to FIG. 1 after a field device has been replaced,

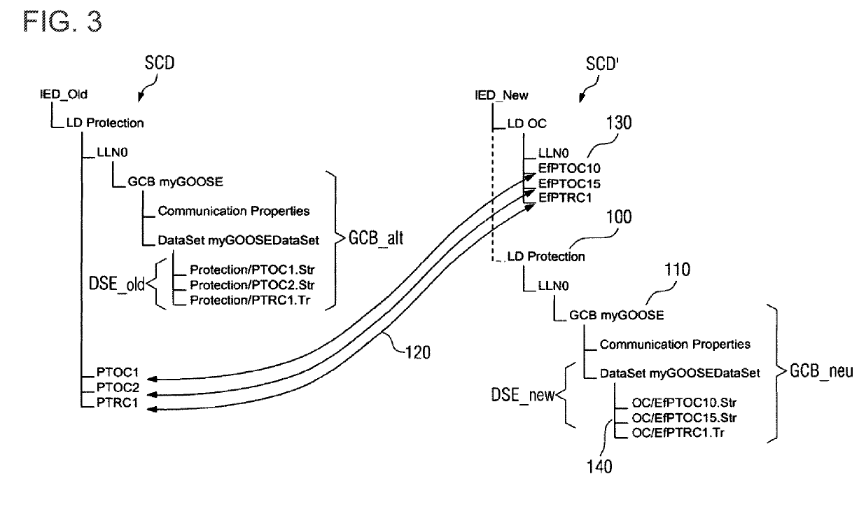

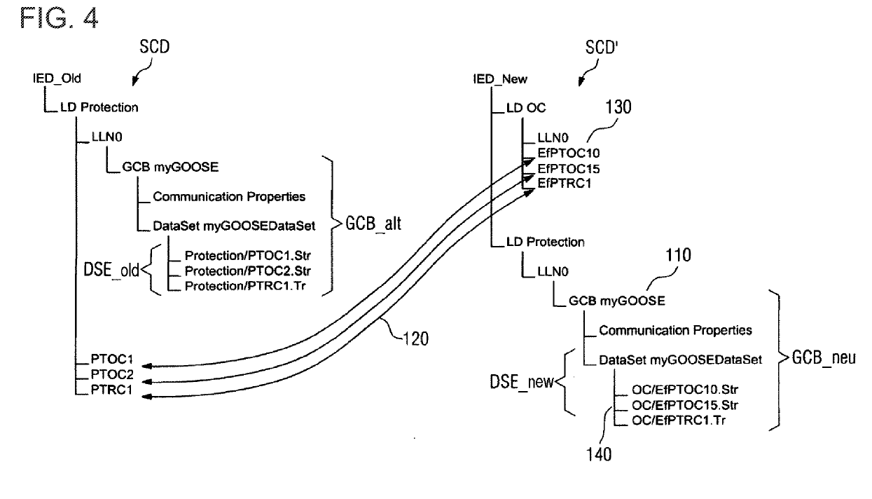

FIGS. 3-4 each show an exemplary embodiment of the process of generating a new command level configuration file with the aid of an ICD property description file which describes the properties of the new field device and an old command level configuration file which describes the arrangement before the field device was replaced.

For the sake of clarity, the same reference symbols are always used in the figures for identical or comparable components.

FIG. 1 shows an exemplary embodiment of a station automation system 10 which is suitable for protecting, controlling or monitoring an electrical switchgear or power supply system (not illustrated any further). The station automation system 10 comprises three field devices IED1, IED2 and IED_old, which may be protective devices for example, and a command level device 20. The devices are connected to one another by means of a communication network 30. The configuration of the arrangement 10 is described by a command level configuration file SCD (cf. FIG. 2).

If one of the field devices, for example the field device IED_old, is now replaced with a new field device IED_new, a new command level configuration file which replaces the old command level configuration file and takes into account the properties of the new field device must be formed. This is shown in more detail in FIG. 2.

FIG. 2 shows the old command level configuration file SCD which refers to the properties of the protective devices IED1, IED2 and IED_old. A new command level configuration file SCD′ is formed with this old command level configuration file SCD and an ICD property description file ICD which describes the properties of the new field device IED_new. This new command level configuration file SCD′ can then also be used, for example, to generate a new field device parameterization data record which can be used to automatically parameterize the new field device IED_new.

A configuration device 40 is provided in FIG. 2 for the purpose of generating the new command level configuration file SCD′. The configuration device 40 may have, for example, a data processing system 50 in which a corresponding control or configuration program 60 is installed.

FIG. 2 also shows a database device 70 from which the device function names of the new field device and the assignment of the device function names of the old field device to the device function names of the new field device can be taken. The database device 70 may form part of the configuration device 40 or may be a component which is separate from the latter.

The method of operation of the configuration device 40 and the data processing system 50 as well as the control program 60 is explained by way of example below using FIGS. 3 and 4.

FIG. 3 shows an excerpt of an exemplary embodiment of an old command level configuration file SCD according to the IEC 61850 standard. Said figure illustrates a “logical device” compartment “LD Protection” inside which the device functions are defined as “logical nodes”. In the case of the field device IED_old, for example, the device functions are called PTOC1, PTOC2 and PTRC1.

The old command level configuration file SCD also shows a “General Object Oriented System Environment” control block (called GOOSE control block for short) GCB_old with a data set entry DSE_old containing references “Protection/PTOC1.Str”, “Protection/PTOC.Str” and “Protection/PTRC1.Tr” which refer to the device functions PTOC1, PTOC2 and PTRC1.

The configuration device 40 will now identify the GOOSE control block GCB_old in the old command level configuration file SCD. In addition, the configuration device 40 will check which “Logical Device” name the GOOSE control block GCB_old in the old command level configuration file SCD is assigned to; this is the “Logical Device” name “Protection” in this exemplary case.

The configuration device 40 then checks whether the “Logical Device” name “Protection” is already present in the new command level configuration file SCD′, for example because it has been taken from the ICD property description file ICD, which describes the properties of the new field device IED_new, by means of copying. If this is not the case, the “Logical Device” name “Protection” is also added (step 100).

The GOOSE control block GCB_old of the old command level configuration file SCD is then instantiated in the new command level configuration file SCD′, for example by copying the GOOSE control block GCB_old, and a new GOOSE control block GCB_new is formed (step 110).

In a further step 120, the configuration device 40 checks whether the device function names of the new field device differ from those of the old field device. In the exemplary embodiment, the device functions in the new field device are called EfPTOC10, EfPTOC15 and EfPTRC1 and are thus different from the device functions PTOC1, PTOC2 and PTRC1 of the old field device.

The device function names EfPTOC10, EfPTOC15 and EfPTRC1 of the new field device can be taken from the database 70 according to FIG. 2 or can be requested from an operator; in a corresponding manner, the assignment of the device function names of the old field device to the device function names of the new field device can also be taken from the database 70 or can be requested from the operator.

In the case of the new field device IED_new, the device functions EfPTOC10, EfPTOC15 and EfPTRC1 are listed, for example, under another “logical device” name, for example the “logical device” name “LD OC”. Accordingly, the configuration device 40 will insert a corresponding “logical device” name “LD OC” in the new command level configuration file SCD′ and will name the device functions EfPTOC10, EfPTOC15 and EfPTRC1 therein (step 130).

In order to take into account the renaming of the device functions in the GOOSE control block GCB_new of the new command level configuration file SCD′, the configuration device 40 will adapt the data set entry DSE new to the device function names EfPTOC10, EfPTOC15 and EfPTRC1 of the new field device IED_new inside the GOOSE control block GCB_new of the new SCD file SCD′. This is carried out by replacing the old entries “Protection/PTOC1.Str”, “Protection/PTOC2.Str” and “Protection/PTRC1.Tr” with new entries “OC/EfPTOC10.Str”, “OC/EfPTOC15.Str” and “OC/EfPTRC1.Tr” which refer to the device function names EfPTOC10, EfPTOC15 and EfPTRC1 under the “logical device” name “LD OC” (step 140).

The new command level configuration file SCD′ is then used to automatically generate a field device parameterization data record—referred to as parameterization data record for short below—which can be used to parameterize the new field device IED_new. Since the message configuration data of the old replaced field device IED_old have been taken into account in the new command level configuration file SCD′, the new parameterization data record will also take into account these old message configuration data and will thus parameterize the new field device IED_new in such a manner that the new field device IED_new behaves in exactly the same manner as the old replaced field device IED_old at that time in terms of data message addressing. The practice of generating a parameterization data record from an SCD file according to the IEC 61850 standard is mentioned in said standard, with the result that reference is made to this standard in this respect.

FIG. 4 shows another exemplary embodiment of the method of operation of the configuration device 40 and the data processing system 50 and the control program 60.

In contrast to the exemplary embodiment according to FIG. 3, the “logical device” compartment “LD Protection” is already present in the new command level configuration file SCD′ in this exemplary embodiment, with the result that said compartment does not need to be additionally instantiated. Step 100 of instantiating the “logical device” compartment “LD Protection” (cf. FIG. 3) is thus no longer required.

For the rest, the method can be carried out as explained in connection with FIG. 3.

1-14. (canceled)

15. In an assembly for protecting, controlling, or monitoring an electrical switchgear or power supply system, the assembly having a command level device and at least one field device connected to the command level device, a method for configuring the assembly, the method which comprises:
generating a command level configuration file describing a configuration of the assembly;
replacing an old field device with a new field device;
subsequently generating a new command level configuration file replacing the first-mentioned command level configuration file and taking into account properties of the new field device and using the new command level configuration file to generate a new field device parameterization data record useful for parameterizing the new field device;
thereby extracting from the old command level configuration file message configuration data that describe a data message generation by the old field device; and
using the extracted message configuration data to form the new command level configuration file and the new field device parameterization data record such that the new field device generates data messages with data message addressing that corresponds to a data message addressing of the old field device.

16. The method according to claim 15, which comprises forming the new command level configuration file using the old command level configuration file and a property description file for the new field device, with the property description file describing properties of the new field device.

17. The method according to claim 15, wherein:
the old command level configuration file is an SCD file according to the IEC 61850 standard and the message configuration data are extracted from the SCD file; and
the new command level configuration file is an SCD file according to the IEC 61850 standard.

18. The method according to claim 16, which comprises using an ICD file for the new field device according to the IEC 61850 standard as a property description file for the new field device.

19. The method according to claim 17, which comprises identifying at least one “General Object Oriented System Environment” control block according to the IEC 61850 standard in the old SCD file.

20. The method according to claim 19, which comprises determining which “Logical Device” name according to the IEC 61850 standard the GOOSE control block in the old SCD file is assigned to.

21. The method according to claim 20, which comprises adding the corresponding “Logical Device” name to the new SCD file if it is not yet present therein.

22. The method according to claim 20, which comprises also setting up the GOOSE control block of the old SCD file in the new SCD file, with assignment to the same “Logical Device” name to which the GOOSE control block in the old SCD file is assigned.

23. The method according to claim 22, which comprises setting up the GOOSE control block in the new SCD file by copying the GOOSE control block from the old SCD file to the new SCD file.

24. The method according to claim 19, which comprises adapting the data set entry according to the 61850 standard to the device function names of the new field device inside the GOOSE control block of the new SCD file if the device function names of the new field device differ from the device function names of the old field device.

25. The method according to claim 24, which comprises:
reading the device function names of the old field device from the SCD file;
taking the device function names of the new field device from a database or requesting the device function names from an operator;
taking the assignment of the device function names of the old field device to the device function names of the new field device from the database or requesting the assignment from the operator; and
adapting the data set entry to the assigned new device function names inside the GOOSE control block of the new SCD file.

26. A configuration device for carrying out the method according to claim 15, configured to form a new command level configuration file using an old command level configuration file and a property description file for the new field device, wherein the property description file describes the properties of the new field device.

27. The configuration device according to claim 26, which comprises a configuration device having a data processing system with a program installed therein suitable for generating the new command level configuration file.

28. A computer program product for installation in a configuration device according to claim 27, which comprises code data compatible with a data processing system which, when loaded into a main memory of the data processing system, is capable of forming a new command level configuration file using an old command level configuration file and a property description file for the new field device, which property description file describes the properties of the new field device.
